(19) United States
(12) Patent Application Publication
(10) Pub. No.: US 2010/0283600 A1
(43) Pub. Date: Nov. 11, 2010

(54) Low power apparatus for preventing loss of cell phone and other high value items

(76) Inventors: Christopher Gary Herbert, Santa Barbara, CA (US); Tyler Rivera Crain, San Diego, CA (US); Christian Johan Smith, Santa Barbara, CA (US)

Correspondence Address: MARK RODGERS, 1590 SAN ROQUE ROAD, SANTA BARBARA, CA, 93105, US

(21) Appl. No.: 12/657,724

(22) Filed: Jan. 25, 2010

Related U.S. Application Data
(63) Continuation-in-part of application No. 12/319,891, filed on Jan. 12, 2009.

(51) Int. Cl. G08B 1/08

(52) U.S. Cl. 340/539.1

(57) ABSTRACT

A system for the prevention of loss of wallets, keys, purses and the like. The system uses a programmable wireless appliance such as a cell phone as a wireless tracker, and utilizes lightweight wireless tag devices attached to the items to protected. A software application executes on the wireless appliance to query the wireless tags and determines when any part of the system is going out of range.

### RELATED APPLICATIONS

This application is a Continuation-In-Part of U.S. application Ser. No. 12/319,891 filed Jan. 12, 2009

Not applicable

### FEDERALLY SPONSORED RESEARCH

Not applicable

### BACKGROUND OF THE INVENTION

The present invention relates to a small device that uses a radio communication terminal that is capable of communicating using a Ultra Low Power (ULP) Bluetooth protocol, or other wireless protocol, and more particularly utilizing the wireless communication protocol to connect to a cell phone and prevent the loss of the cell phone or item the device is associated with.

Mobile telephones have evolved to be an essential item that most people carry along with their keys and wallets or purses. Mobile phones have also evolved to run multiple applications and contain critical information, such that the loss of a phone can be as or more detrimental as losing one's wallet or keys. Currently, preventative solutions for protecting all one's critical items, such as wallets, purses, keys, and/or mobile phones, are either ineffective or cumbersome to use.

One current method of recovering phones uses GPS tracking. Although GPS can successfully locate the position of the phone, GPS tracking is not a preventative solution to loss and offers no solution for protecting one's wallet, keys, or other items from loss or misplacement.

U.S. Pat. No. 5,796,338 by Aris Mardirossian discloses a system for reducing the risk of loss or theft of a cellular telephone. The system includes a wireless transmitter in a cell phone that sends signals to a device worn by the user. The device worn or carried by the user includes an alarm to notify the user when signal received by the device drops below a given strength. The patent does not address battery power consumption on the cell phone and the device through a transmission method.

U.S. Patent Application No. 2007/0129113 by Michael Edward Klicpera discloses an alerting apparatus and method for alerting the owner of a cell phone that their cell phone has exceeded a given distance between the owner and the cell phone. The alerting system is triggered when the cell phone and an alerting device associated with the user are separated by a set distance. The method does not address the number of signals transmitted and reduce the battery power consumed by the mobile device and item device.

U.S. Pat. No. 6,002,334 by Joseph L. Dvorak discloses a method to connect items to a tracking device in order to monitor the separation distance between items and a tracking device. The tracking device will issue an alert if the separation distance exceeds a predetermined amount. The tracking device measures the separation distance whenever the tracking device is moved away. This method is wasteful of battery power.

U.S. Pat. No. 6,331,817 by Steven Jeffrey Goldberg discloses an apparatus and system to track and report when an object is not near an expected location, object, or person. The personal assistance tracking device keeps track of a plurality of devices. The device monitors the items based on the location of the tracking device relative to locations of transducers. The items tracked by the tracking device can report their position wirelessly to the organizer through RF, Bluetooth, or infrared. The use of a separate location transducer is needed to determine the items to be tracked by the tracking device.

U.S. Pat. No. 6,674,364 by Paul Robert Holbrook discloses an object finding system that enables users to locate lost or misplaced items. The items are tracked by an extra device the user carries. This system uses passive tracking to locate the devices when the user is looking for an item.

U.S. Pat. No. 7,098,786 by Joseph L. Dvorak discloses a system for tracking objects using a cell phone. The system uses a unique tracking profile based on the user's location and time. The power of the signal sent by a cell phone or device is modified, adjusting the energy per pulse of the signal. A comparator is used to determine whether each transponder is within a predetermined coupling range profile. In this design, the phone measures the signal strength sent from the device. This method is wasteful of the phone's battery.

U.S. Pat. No. 6,885,848 by John-Gy Lee discloses an apparatus that prevents phone loss by establishing a Bluetooth connection between an audio headset and mobile phone. When the phone becomes more than a user defined distance separated from the headset, the headset rings and alerts the user that he/she is about to lose his/her phone. This method does not protect users' wallets, keys, or other items. This method also consumes a large amount of power due to the need for a calling state to be established and the use of conventional Bluetooth. The method also, requires the user to be using a wireless headset.

U.S. Pat. No. 7,002,473 by Larry D. Glick discloses a loss prevention system that comprises a base monitoring unit and articles marked by RFID tags. The base unit periodically interrogates the marked items and alerts the user if the marker does not reply or is out of range. This solution requires the user to carry an extra device.

US Pat. Application No. US2007/0042714 by Mourad Ben Ayed discloses a portable loss prevention system that uses a base unit Bluetooth transceiver that automatically detects Bluetooth devices in the vicinity. On detected movement, the device checks for devices again and if a device that was detected before is not present, the base unit will alert the user that their device is gone. Although this approach is able to track and detect mobile phones as well as keys, wallets, etc., it is bulky, uses excessive battery, and requires the user to carry an extra device.

US Pat Application No. 2008/0125040 by Nicholas Kalayjian discloses a system for locating objects by using a Bluetooth radio. A small slave device is paired with a master device such as a cell phone. The master device can trigger the slave device to ring by sending a command. The master device can display the location of the slave device by using time delay or triangulation. This system focuses on finding items instead of preventing loss and does not utilize the signal power in tracking the separation distance.

International Pat Application No. PCT/GB2008/000148 by Ben Hounsell discloses a system comprising of Bluetooth devices connected to valuables. The devices interact with a cell phone that is able to track the distance from the devices using RSSI, BER, and delay means. This patent does not address the problem of minimizing battery life.

There is a need for a simple, low power system that does not require the user to carry an additional item to and is conveniently applicable to prevent the loss of high valued items such as cell phones, wallets, keys, etc.

### SUMMARY OF INVENTION

The invention is a system for preventing loss of personal belongings which includes a device containing a radio chip, battery, and a micro processing unit; an application adapted to execute on the device, such that whenever the application periodically syncs with a cell phone, or other programmable mobile communications device, the device determines the signal strength between the phone and the device. If the signal strength has not changed by a predetermined amount, no data is exchanged between the device and phone. If the signal strength or power has changed by a predetermined amount, the device wirelessly sends the new power reading, thus limiting data communication when nothing has changed, thereby conserving battery power in both the phone and the device. The invention also includes an application adapted to execute on a cell phone or other wireless programmable appliance, where the application responds to signal power information from the device, and alerts the user when the received signal power level from the device is less than a predetermined level.

In a preferred embodiment, the radio chip is a Bluetooth chip or ULP Bluetooth Chip and the device radio chip follows Bluetooth communications protocol. In a particular embodiment the alert includes the cell phone ringing, vibrating, and/or using a visual means. In another embodiment, the alert distance can be determined by the user. The software also has the ability to lock down the phone and make the phone become unusable until a password is entered.

### BRIEF DESCRIPTION OF THE DRAWINGS

The invention will be better understood by referring to the following Figures:

FIG. 1 is a schematic and block diagram of the tracking device according to an embodiment of this invention.

FIG. 2 is a schematic and block diagram of a cell phone

FIG. 3 is a block diagram highlighting the number of signals sent between the phone and device.

FIG. 4 is a flow chart of the tracking device operation.

FIG. 5 is a flow chart of the firmware execution on the device.

FIG. 6 is a flowchart for the start up sequence of the software application running on the phone.

FIG. 7 is a block diagram highlighting the number of signals sent between the phone and device.

FIG. 8 is a flowchart of the algorithm used to improve the accuracy of the signal power measurements.

### DETAILED DESCRIPTION OF THE INVENTION

It is an object of the present invention to provide an apparatus and method for preventing the loss of mobile phone, wallet, keys, purse, and other high valued items in a means that is precise and uses minimal battery power.

Existing approaches of monitoring the absolute or relative location of valuables based on using wireless technology exist. These systems rely on utilizing extra devices attached to personal items communicating through a wireless communications protocol to a central unit. The central unit is often a bulky second device that is burdensome for the user to carry. These systems do not address the main problems of having a limited battery lifetime and the accuracy of distance measurements. The constraints on device operating time and size restrict the usefulness of such a system.

The inventors have realized that most people carry smart cell phones and the world is moving toward more and more people having such phones. Thus the inventors have conceived of a loss protection system where the phone is the tracking unit, thereby eliminating the need for a separate unit. Smart phones already have relatively powerful wireless capability, including Bluetooth in most cases, and have programmable controllers that can run third party software, and have long-life battery systems. Thus the phone can be programmed to serve as the tracking unit, in a symmetrical fashion, such that when any one of the tracked items is moving away from the other items, including the phone, the user can be alerted.

An exemplary system is described herein, for purposes of disclosure of a working example of the invention. It is to be understood that variations on the described system, such as other wireless protocols, or using other common wireless, programmable devices such as PDA's, will occur to those skilled in the art. The broad invention, as claimed is intended to include such variations.

A mobile phone runs software and is able to connect wirelessly to a small device. An RF standard such as Bluetooth or ULP Bluetooth is used to enable communication between the mobile phone and device. The device is attached to one's valuable items such as belt, wrist band, jewelry, clothing items, glasses, shoes, watches, hair accessories, luggage, backpacks, MP3 player, portable electronic devices, laptop, cameras tools or measuring devices. The device can be attached through mechanically fastening, clipping, gluing, or taping the device to the item. The device can also be attached to children and pets via a band or collar. The device begins in a low power mode and is put into a state such that it is discoverable to other Bluetooth enabled devices. The phone connects to the device and the device detects that it has been connected to and enters into a minimal battery power consumption state. The device is programmed to sync with the phone periodically, which allows the device to read the signal strength of the connection using the Bluetooth Received Signal Strength Indicator function. The time period is based on a user defined or preset time interval. The received signal power read is written to the device's memory and compared with the previous signal power reading. If the received signal power has changed by more than a predetermined amount, the device sends the new power reading to the phone. If the received signal power has changed by less than a predetermined amount, the device does not send anything to the phone and enters into a low battery power consumption state. Thus data communication only occurs if the distance between device and phone changes significantly. One implementation of determining what a significant change in distance means is to organize the possible signal power readings in predetermined zones. If the signal power read is classified as being in a different zone from the previous signal power reading, a data communication will occur. The sync/read signal strength step is a relatively low power operation compared to data exchange. Although it is theoretically possible to use the Received Signal Strength Indicator function on the phone side Bluetooth, in practice most popular smart phones such as i-Phone and Blackberry do not allow third party application programmers access to low level functions. So measuring the signal power and thus phone-device separation must be done on the device side and accordingly minimizing data communication has a large impact on battery life.

When measuring the signal power, an algorithm is run on the device to filter out inaccurate measurements. The algorithm is initiated whenever there is a large change in received signal power. This large change in received signal power indicates that the device is moving or has been moved away from the phone. This initial signal power measurement is often inaccurate because of the sudden change in received signal power. The algorithm checks if the measured received signal power has changed by more than “Q” amount. If the received signal power has changed more than “Q”, then the filtering algorithm is run.

The filtering algorithm runs as follows. Note that in order to make the computations simpler, all RSSI values, including the value “Q”, are normalized to a value from 1 to 100. Once the algorithm starts the device immediately performs the RSSI function to attain a new received signal power measurement. The RSSI function is repeatedly rerun a maximum of “Y” times or until a confidence level of 100 is attained. The confidence level refers to a number ranging from 1 to 100, where 1 means little confidence and 100 means very high confidence that the received signal power measured is correct. Each time the algorithm is run the confidence level initializes at 50 and is risen with each new received signal power reading that varies less than “Q” from the previous received signal power reading. The confidence level decreases when the read received signal power has changed by more than “Q” from the previous signal power reading. The amount the confidence level increases or decreases is based on how close the difference is to “Q(normalized)” and is implementation and hardware specific. An exemplary formula is a quadratic function where values close to “Q(normalized)” modify the confidence level very little, while values further away from “Q(normalized)” change the confidence level by a larger amount. Once the confidence level criteria has been met or after “Y” signal power measurements, the received signal power is decided upon. The reported received signal power can be the last read received signal power value or an average of past read received signal power values.

Determining the threshold values of “Q” and “Y” are implementation and hardware specific. When the device and phone are stationary, there will be small fluctuations in the received RSSI values over time; the value for “Q” should be slightly larger than this, so the filtering algorithm is only executed when some change in the environment occurs. The value for “Y” should be based on the speed the algorithm can be executed, which will predominately depend on the time it takes for the RSSI function to report back the received signal power. If a confidence level of 100 is not reached within a second, the “Y” threshold should be reached to complete this run of the filtering algorithm. This allows the system to continue to be responsive even in the case of a possible inaccurate measurement. The exact threshold values should be determined through experimentation for the specific hardware being used. Once the algorithm is completed, the most recent RSSI value is used.

The above algorithm helps filter out inaccurate measurements at a very minimal time scale, in order to give an even more realistic distance reading in terms of standard units such as meters, a machine learning algorithm can be used in addition to the filtering algorithm. This machine learning algorithm uses a set of the “X” most recent signal strength readings as the input and outputs a real distance measurement. The reason why multiple input values are used is that in a real environment objects are moving and there are large number of variables impacting the signal strength in a way unknown to the RSSI function, so a single reading will not give the most accurate distance. Deciding how these previous readings impact the actual current distance is a very difficult problem that can only be based on prior knowledge. The machine learning algorithm takes care of this problem. By being trained by a large set of previous training examples with valid inputs and correct outputs; the algorithm uses this prior knowledge to determine a more accurate distance from the current set of inputs. Implementation details are described in the following paragraph.

In order to receive accurate distances the machine learning algorithm requires a large set of training examples. There must be at minimum a few hundred training examples and more optimally a few thousand training examples generated using many different real world usage conditions. This should include as many repetitions as possible of as many different use cases as possible. Some of these include when the device and phone are stationary at many different distances, when the device and phone are in different pockets, when the device is left on the table and the user walks away at different rates, etc. The training examples should have a structure similar to the following: The inputs will be a list of the last“X” signal strength readings, ordered with the oldest reading first in the list and the newest reading at the end of the list. The value for “X” is implementation specific, but the number should contain readings from the last 1 to 3 seconds. A number that includes older readings is unnecessary because signal power readings taken from longer than 3 seconds ago will have little relation to the most recent reading. If desired, more signal strength readings can be used at the expense of increased memory and computations, and could be beneficial in certain use cases.

The output of a training example is the actual real world distance measured corresponding to the most recently measured signal power reading. These training examples will be used to train a machine learning algorithm such as an artificial neural network. An artificial neural network is a good solution because it is not sensitive to errors in the training data which is necessary because the signal strength readings are not perfectly accurate. Another reason for using a neural network is that it can be trained ahead of time on a powerful computer, and then once it is trained it can be moved to the device where it can operate using minimal space and computation requirements. In order to train the neural network the standard back propagation can be used. Other algorithms can also be used to train the network if desired for more specific implementations and will be obvious to those skilled in the art.

The size and structure of the neural network will be determined by how many training examples there are and how well they can be trained. A good structure for our implementation with around 1000 real world training examples is a network with 6 inputs. The inputs correspond to 2 seconds of readings, 2 hidden layers, the first hidden layer with 6 units, and the second hidden layer with 3 units, and a single output unit. The network is trained on a powerful computer using the training examples and the back propagation algorithm until the error rate on the training examples has reached an acceptably small level. This error rate is implementation specific and depends on the set of training examples as well as the network structure. It is also helpful to use a separate validation set during training to help prevent overfitting. Overfitting means the network has been trained too much on the set of training examples, causing the accuracy for this specific set to be high, but the general accuracy of the network is decreased for training examples not in this set. Since the RSSI function is not always accurate and the training data is likely to have errors in it, overfitting is likely. In order to use a validation set, the back propagation algorithm is run on the normal training set. Checking the error rate is done on the separate validation set. Once the network has been successfully trained, the resulting network data consisting of the set of weights used for each of the units in the layers of the network, is copied to the device where it is used to compute accurate distance readings. Note that the actual training examples are no longer used and are not transferred to the device, the network structure and weights are transferred to the device. On the device the neural network structure is the same (as described by the procedure in the previous paragraph), it will take the “X” most recent RSSI readings as input. The output of the neural network is the standard unit distance measurement for the most recent received signal strength reading.

With the neural network structure set up, the system is able to run the power checking algorithm. The phone receives the signal power readings from the device and if the received signal power reading is less than a user selected level, the phone alerts the user through an audio, visual, and/or vibrating means. This functionality may also be implemented by using the bit error rate function and/or the pinging function to convey separation distance. Thus the novel device and cell phone application decreases the amount of battery power used to send signals by minimizing the number of actual data communication between the devices and smart phone. A preferred detailed embodiment of the present invention will be described herein below with reference to the accompanying drawings. Some time increments, such as wait or sleep times will depend on system configuration and will be apparent to one skilled in the art. Signal Power ranges will be denoted by “x” or “small power range” in the following description.

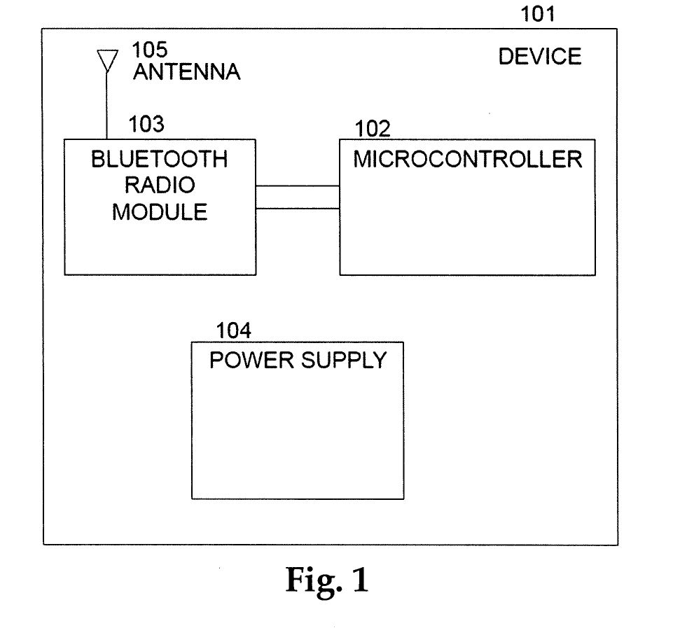

FIG. 1 is a block diagram of the device with a hosted implementation scheme. The device 101 consists of a microcontroller 102, Bluetooth radio module 103, a power supply 104, and an antenna 105. The device 101 uses the program memory within the microcontroller 102. The Bluetooth radio module 103 includes the necessary firmware to communicate with other Bluetooth devices. The Bluetooth module 103 and the microcontroller 102 communicate using UART protocol or other communication protocol. The power supply 104 can be a battery, solar cell, or other means of powering the device. The antenna 105 is used to receive and transmit signals to the cell phone. The antenna 105 is listed as an extra component but may be included within the Bluetooth radio module 103. Only the main components required for the device are shown and other necessary components such as capacitors, resistors, inductors, and additional programmable flash memory are not listed but it is recognized that additional components are necessary in order for the device to be functional. A piezo buzzer can also be added on the device to enable the device to ring and/or vibrate when the signal power has dropped below a set level. A button or other user input device can be added onto the device to allow the user to turn off the alarm system manually.

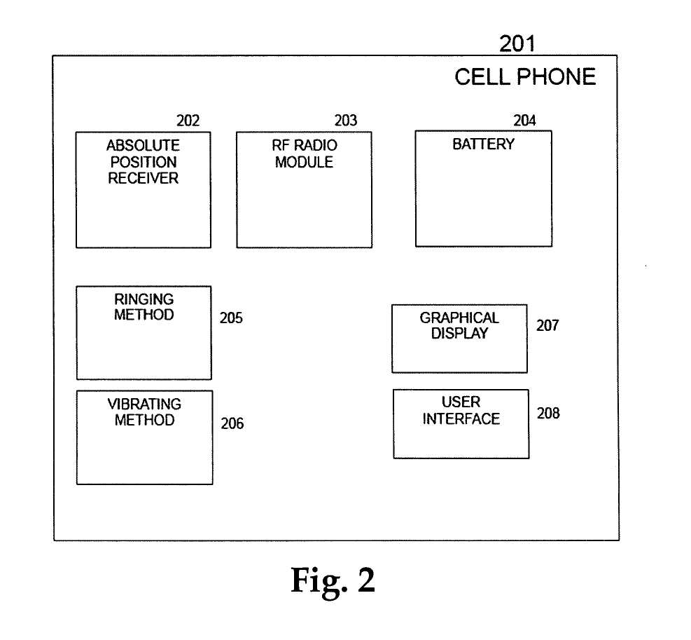

FIG. 2 shows a cell phone 201 containing the following parts. The absolute position receiver 202 can be GPS or means of obtaining the absolute position of the phone. The RF radio module 203 can be Bluetooth or another wireless protocol such as Zigbee. The Bluetooth radio module 203 includes the necessary firmware to communicate with other Bluetooth devices. The power supply 204 can be a battery, solar cell, or other means of powering the cell phone. The cell phone is equipped with alerting methods such as a ringing method 205 or a vibrating method 206. The cell phone will also be capable of receiving user input through a user interface 208 such as a touch screen, a keyboard, button pad, or track wheel. Output is shown on a Graphical Display 207.

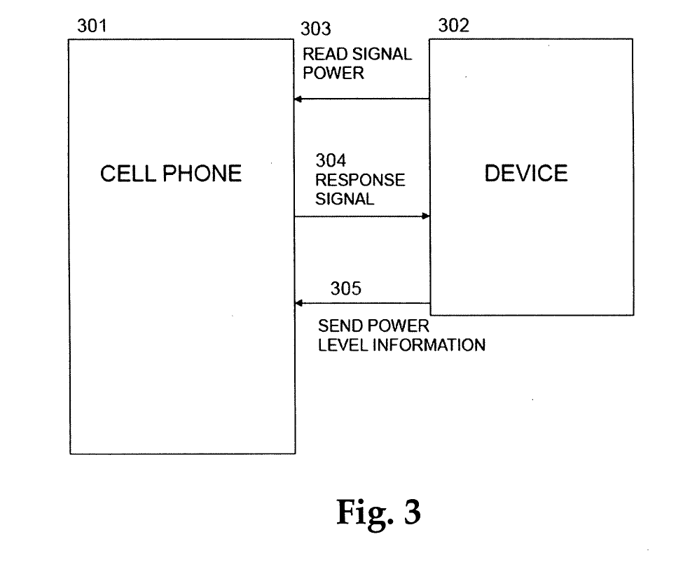

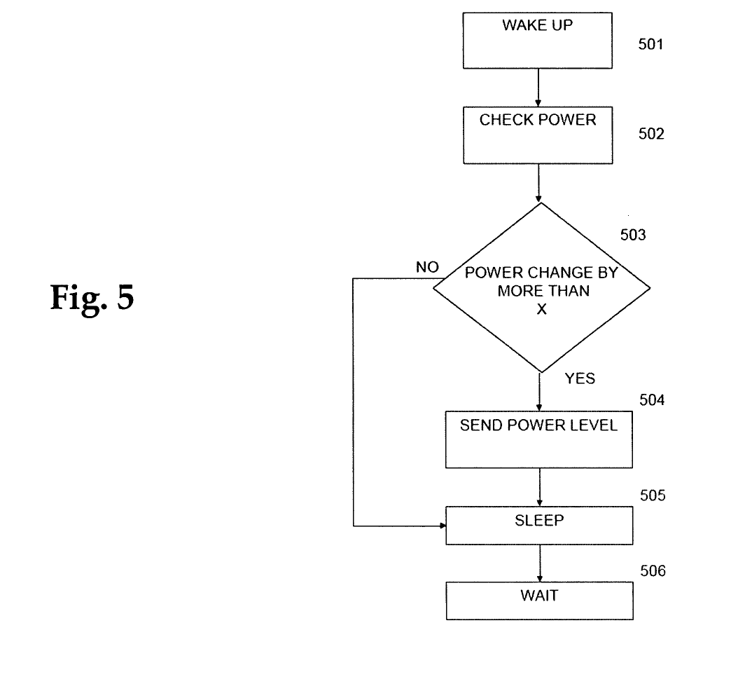

FIG. 3 is a block diagram that illustrates the number of signals sent between the two devices. In this example, the device 302 reads the signal power 303 by synching with the cell phone 301. The cell phone 301 sends a response signal to the device 302 carrying the received signal power indication. This process described can be implemented by the Received Signal Strength Indicator function. The Device 302 then runs the battery power saving method outlined in FIG. 5 and decides whether to send the signal strength level information 305 back to the cell phone 301 or and return to low battery power consumption state. In the inventors' method, the signal strength will not need to be sent the majority of the time, resulting in cutting the battery power used by a third.

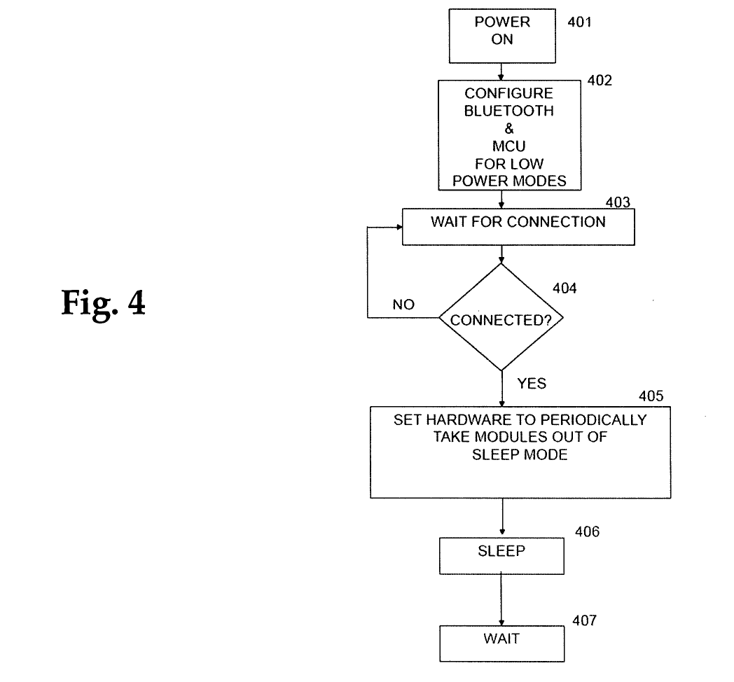

FIG. 4 is a flowchart illustrating the operation of the firmware on the device when the device is first powered on. The device is powered on 401 and configuration sequence 402 initiates the Bluetooth and microcontroller to run in a low battery power consumption state. This mode means setting the microcontroller into a sleep mode and setting the Bluetooth into a sleep mode where it is able to still receive inquiries from other Bluetooth devices. One specific implementation is to set the Bluetooth module into Sniff mode and set the microcontroller to sleep with UART receive interrupts enabled. The device waits for a connection 403 from the mobile phone 404. When connected 404, the device configures itself to schedule periodic interrupts 405 where the device exits out of a low battery power consumption state in order to interact with the phone. The frequency of the device going out of low battery power consumption state may be set by the user from software running on the phone or may be a preset value. Once this scheduling has been set, the device enters into a low batter power consumption sleep mode 406 and the device waits 407.

FIG. 5 is a flowchart illustrating the firmware on the device running the battery power saving signal strength check method. The device wakes up 501 from low battery power consumption sleep mode. The device can be taken from the low battery power consumption state using a clock timer interrupt or by a command received from the cell phone. The device checks the signal strength 502 between the phone and device. The signal strength may be measured from a variety of means including and not limited to the Received Signal Strength Indicator function, the Bit Error Rate, and Ping times. The signal strength power is compared to a previous filtered signal power value, average signal power value, or preset signal power value 503. If the signal strength has changed by more than X amount, the device sends the signal power level 504 reading to the mobile phone and then proceeds to enter the low battery power consumption sleep mode 505 and waits 506. The signal power level sent 504 may be conveyed by, but not limited to a numerical signal power value, an exact distance value, or a distance range value. If the signal strength has changed by less than or equal to X amount 503 returns false and the device enters into low battery power consumption sleep mode 505 and waits 506.

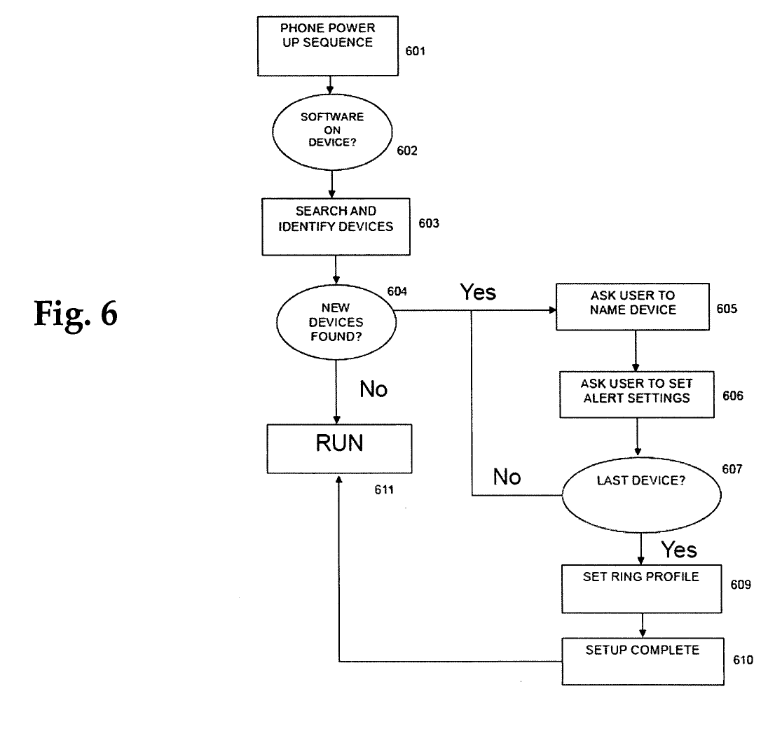

FIG. 6 is a flowchart of the boot up operation sequence. The phone is turned on 601 and checks if the software is loaded onto the mobile phone 602. If software is loaded on the phone, the phone will search for new devices 603. When new devices are discovered 604, the phone will ask user to name the new devices 605. If no new devices are found, the program will enter into the RUN sequence 611. After the user names the device, the user will be prompted by the application to set up the alert settings 606 including the alert distance, alert method, and other settings. The program checks if the device that has been set up is the last device 607. If not, the program will loop through steps 605 to 607 until all identified tracking devices are set up. Once all devices have been set up, the program will implement the ring profile 609, exit the set up 610, and enter into RUN sequence 611.

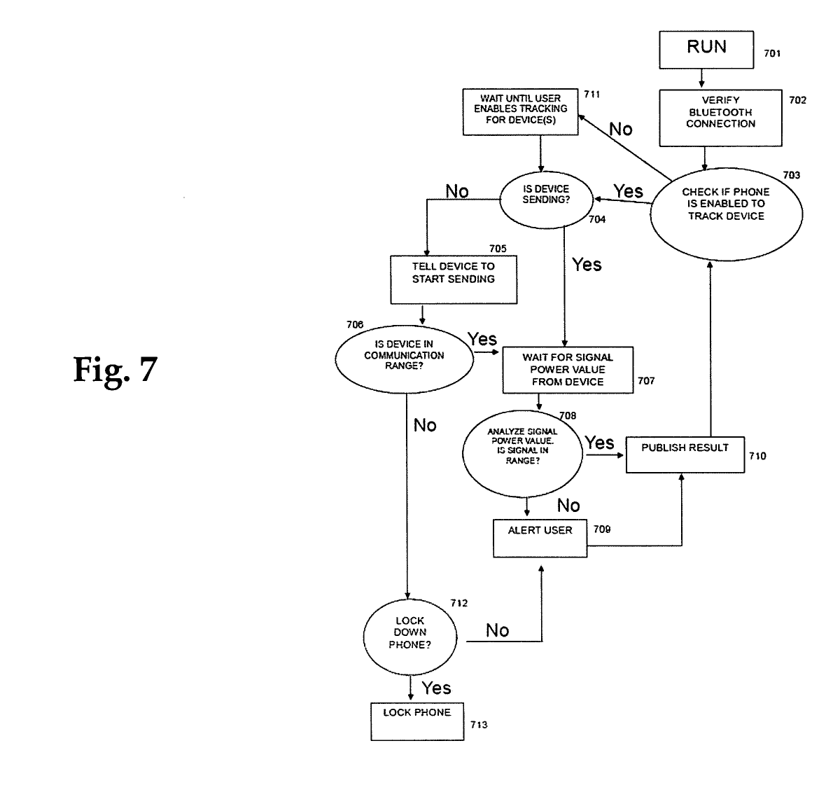

FIG. 7 describes the flowchart of the phone software during the RUN sequence for a single device. The phone begins the RUN sequence 701 and verifies the wireless connection 702 with the tracking device. The software checks if the device is set to be tracked 703 by the phone. If tracking is not enabled for device on the phone 703, the phone waits until the user enables tracking for the device 711. If phone is enabled to track the device 703, the phone checks to see if the device is sending 704 signal power information to the phone. If the device is sending signal power information, the phone waits to receive signal power values from the device 707.

If the device is enabled but not sending signal power information 704, the device is given the command to start sending signal power information 705. The phone checks if the device is within communication range 706. If the device is out of communication range, the software checks if it should lock down the phone 712. If lock down is enabled on the phone, the phone locks down 713 and is able to become unlocked when the user inputs the correct code. After the phone is unlocked, the phone reverts back to the power up sequence 101 in FIG. 1. If lockdown is not enabled, the phone proceeds to alert the user 709 through an audio, visual, and/or vibrating means.

If the device is within range, the phone waits for the signal power information from the device 707. The signal power value will be analyzed in 708 by the phone when the information is received. The phone will alert the user if the distance value is out of range 709. When the phone issues an alert 709 to the user, the phone also has the ability to record the GPS position and store the information so the user is able to recall the area where the item was misplaced. If the received signal power value is within range, the result will be published to the user interface 710. After publishing the results, the application checks the tracking status 703. The loop back to 703 will allow the user to disable device tracking in the case the item raises a false alarm or the user does not desire to track the item any longer.

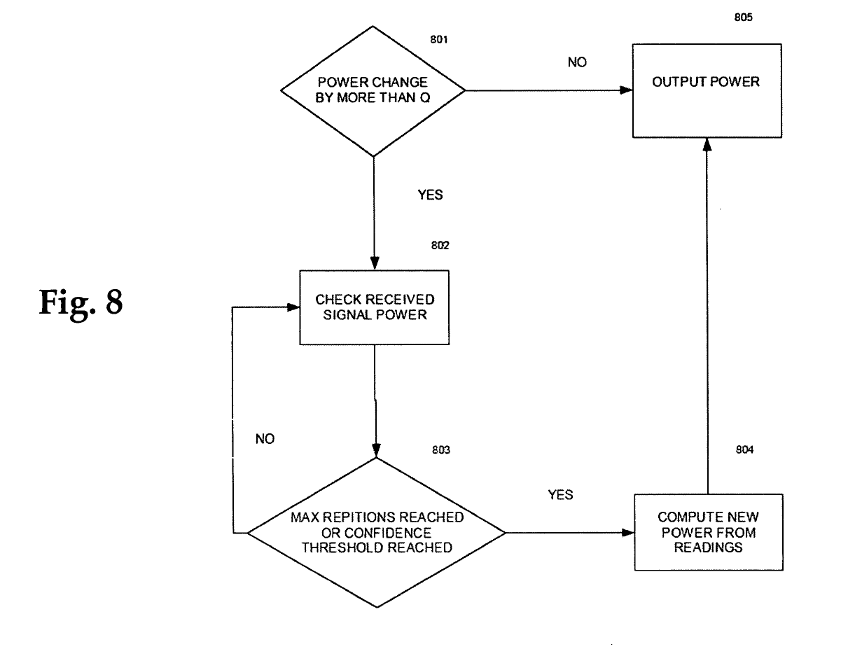

FIG. 8 describes the flowchart of the error reducing algorithm. This algorithm takes place after the check power 502 step in FIG. 5. The device then checks if the signal power measured has changed by more than “Q” since the last signal power measurement 801. If the signal power measured has not changed by more than “Q”, the device will output the power 805 and the device will return to the signal power checking algorithm. If the signal power measured has changed by more than “Q”, the device will run the filtering algorithm as described earlier and measure the received signal power again 802. The device will continue to repeatedly measure the received signal power until the maximum number of signal power measurements are completed or the confidence level threshold has been met 803. Once this prerequisite has been met, the device will take the most recent signal power reading 804 and report the signal power reading 805. After reporting the signal power reading, the device will return to the signal power checking algorithm.

It is envisioned that a user will preferably download the software install package from the internet and install it onto their phone although other means are possible. Once installed the user will preferably have an easily accessible button on their home screen allowing him to enable or disable the program or to open the settings dialog. From the settings dialog the user will be able to choose any sound file located on their phone for the software to play (the default will just be a beep). From the settings screen the user will also be able to set the volume that the sound should be played at (if the user wants the volume to be different from the ring volume) and modify the address of the external Bluetooth device. There will also preferably be an icon showing the status of the device (if it is enabled and working, or disabled).

Once the user activates the program, a service will be started on the phone running in the background. The service will start by creating an asynchronous connectionless link (ACL) with the external Bluetooth device (using its address from the settings dialog). This type of connection is used because it has all the functionality needed and uses less power than an SCO Bluetooth connection.

The external Bluetooth device will use the standard Bluetooth stack and compatible with later versions of the Bluetooth specification. When the device is on and in “normal” mode (not in “discovery” mode), it will have the Bluetooth radio enabled allowing ACL connections, but it will not be discoverable nor will it have a full Bluetooth connection with any device (this will reduce power consumption).

It is desirable that this software makes a minimal impact on the power consumption of the phone. In order to do this the application will preferably run as a background service still allowing the phone to go to sleep, and only use minimal CPU and Bluetooth (when the device sleeps the CPU and Bluetooth by default do not actually power down, and the application will take advantage of this) cycles while letting the rest of the device to power down. When the software needs to alert the user, it will power up the necessary hardware on the device and alert the user. Once it is done it will power back down the hardware to its previous “sleep” power level.

We claim:

1. A system for monitoring the distance between a mobile communications appliance and a tracking device comprising:
At least one tracking device comprising an RF radio, programmable logic, and battery; adapted to
establish a connection between the device and the mobile appliance,
periodically measure and store the signal strength of the connection, wherein the signal strength is filtered by an algorithm executing on the programmable logic to reduce inaccuracies in the measured signal strength,
compare the signal strength to previously stored values; and,
communicate data including least one of the signal strength or a parameter derived from the signal strength to the mobile appliance when the signal strength varies from stored values by a predetermined amount; and,
an application executing on the mobile appliance adapted to alert a user when the data communicated from the tracking device indicates the separation between the tracking and the appliance exceeds a predetermined distance.

2. The filtering algorithm of claim 1 comprising a trained neural network.

3. The filtering algorithm of claim 1 wherein the algorithm is triggered by a large change in signal strength thereby determining the accuracy of current signal strength measurement.

4. The filtering algorithm of claim 3 wherein the large change in signal strength corresponds to a predetermined threshold.

5. The filtering algorithm of claim 1 wherein accuracy of current signal strength is determined by a confidence level reaching a predetermined threshold.

6. The filtering algorithm of claim 5 wherein if the confidence threshold is not achieved within a predetermined number of signal strength measurements, the current value is decided upon.

7. The system in claim 1 wherein the predetermined change in signal strength value is set by the user.

8. The system in claim 1 wherein the tracking device is assigned parameters such as but not limited to name, ring settings, and notification distance.

9. The system of claim 1 wherein separation distance is further delineated into distance zones.
